(19) United States
(12) Patent Application Publication
(10) Pub. No.: US 2005/0009669 A1
(43) Pub. Date: Jan. 13, 2005

(54) Non-motorized treadmill exercise device

(76) Inventor: Robert D. Harris, Logan, UT (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/616,583

(22) Filed: Jul. 9, 2003

(51) Int. Cl. A61H 3/00

(52) U.S. Cl. 482/69

(57) ABSTRACT

An exercise device includes a harness operably coupled to a manually-operated treadmill. The harness includes an elongated member having opposed ends adapted for engagement together around a waist of a user of the treadmill. One or more resistance bands comprised of a resiliently flexible material extending between the harness, and treadmill or an object fixed relative to the treadmill such that resistance to forward movement of the user occurs as the user manually operates the treadmill.

### BACKGROUND OF THE INVENTION

The present invention generally relates to exercise devices, such as treadmills. More particularly, the present invention relates to an exercise device for providing resistive training for a user of a manually-operated treadmill.

The use of treadmills for walking, jogging and running purposes is well-known. Oftentimes, the treadmills are motorized such that the user can select a speed or pre-programmed course for the exercise regiment. The motor of the treadmill then moves the belt, or running surface, to the appropriate speed matching that selected by the user. The user must then walk, jog, or run at this speed so as to remain generally stationary on the treadmill. To alter the speed of the belt, the user must push the appropriate buttons on the controlling console.

Some of the drawbacks of a traditional motorized treadmill include the need to alter the speeds and programming of the treadmill during use, which can be difficult while running at a fast pace. Moreover, there is no resistance, other than inclining the running surface, in traditional treadmills.

It is known that providing resistance to a runner cannot only increase the cardio aspect of the workout, but also serve to strengthen muscles which improve performance and strength. For example, U.S. Pat. No. 5,167,601 to Frappier discloses a leg muscle training device wherein leg bindings secured above and below the knee are connected to a stretchable tether which is held by a trainer. As the athlete runs in place or on a treadmill, the trainer pulls on the tether to create a desired degree of resistance. It has been found that this apparatus is particularly useful for sprinters or other athletes involved with sprint running. However, the Frappier training device and method requires a personal trainer to be utilized and has a fairly cumbersome set-up.

Accordingly, there is a continuing need for an exercise device which provides resistive training for a user of a manually-operated treadmill and which does not require the assistance of another individual but provides the benefits of resistive training. The present invention fulfills these needs and provides other related advantages.

### SUMMARY OF THE INVENTION

The present invention resides in an exercise device for providing resistive training for a user of a manually-operated treadmill. In one embodiment, the treadmill comprises a support structure including parallel rails and a leading roller rotatably attached to the rails at one end of the support structure, and a trailing roller rotatably attached to the rails at an opposite end of the support structure. A continuous belt track extends between the rollers so as to be manually rotated by the user as he or she walks or runs on the treadmill.

A harness is coupled to an object fixed relative to the treadmill, such as an object in close proximity to the treadmill, or directly attached to the treadmill itself. In a particularly preferred embodiment, a rearstanchion extends generally perpendicular to the support structure at a rear end thereof. The harness is defined by an elongated member having opposed ends adapted for engagement together around a waist of a user of the treadmill. One or more resistance bands, comprised of a resiliently flexible material, have a first end coupled to the harness, and a second end coupled to the stanchion or object in close proximity to the treadmill. Thus, as the user of the treadmill attempts to advance, resistance to forward movement of the user is experienced.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side perspective view of an exercise device embodying the present invention and including a manually-operated treadmill and a harness;

FIG. 2 is a front perspective view of an exemplary harness of the present invention;

FIG. 3 is a rear perspective view of the harness of FIG. 2, illustrating resistant bands attached thereto;

FIG. 4 is a side perspective view of the exercise device of the present invention, with the harness thereof coupled to a waist of a stationary user of the treadmill, illustrated in phantom; and

FIG. 5 is a side perspective view similar to FIG. 4, illustrating the user operating the treadmill and experiencing resistance to forward movement.

### DETAILED DESCRIPTION OF THE PREFERRED EMBODIMENTS

As shown in the accompanying drawings for purposes of illustration, the present invention resides in an exercise device, generally referred to by the reference number 10, which is designed to provide resistive training to the user.

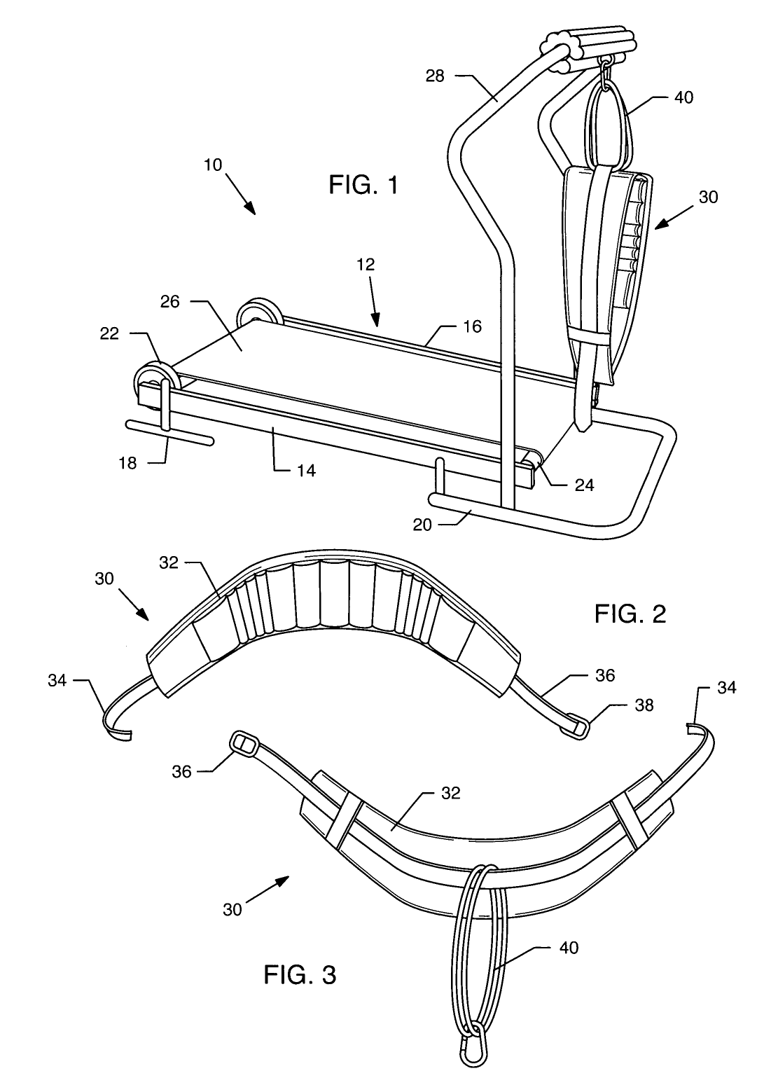

With reference now to FIG. 1, the device 10 is comprised of a manually-operated treadmill 12. The treadmill 12 can be of various designs, but typically includes a support structure including parallel support rails 14 and 16 which are raised from the floor by the use of supporting legs or brackets 18 and 20. A leading roller 22 extends between leading edges of the support rails 14 and 16 and rotatably attached thereto. Similarly, a trailing roller 24 is rotatably interconnected between trailing ends of the support rails 14 and 16. A flexible continuous belt 26, or other appropriate rotatable support surface, extends over the rollers 22 and 24 such that as the user walks or runs thereon, the belt 26 rotates under the user.

Preferably, the treadmill 12 is not motorized such that the user must manually activate and move the belt 26 as the user walks or runs. This enables the user to have much more control over the speed of the belt 26 while also providing a degree of resistance training as compared to motorized treadmills. It is contemplated by the present invention that the deck, or walking supporting surface including the belt 26, could be raised above horizontal for training and resistance purposes. Any means known in the art could be utilized for such purposes, including a motorized lift assembly, or a manual lift assembly including hinges and brackets and the like. In this way, the leading roller 22 could be elevated with respect to the trailing roller 24 to simulate walking or running on hills.

In a particularly preferred form of the invention, a stanchion 28 extends upwardly from a rear end of the treadmill 12. The stanchion 28 is generally U-shaped and inverted such that the free ends thereof are attached to the rear of the treadmill 12. The stanchion 28 provides a convenient location to secure a harness 30. As shown in FIGS. 1-3, the harness 30 includes an elongated member 32 having opposing ends 34 and 36 which are adapted to be coupled with one another. Any means of coupling are contemplated by the present invention, including the illustrated buckle 38 through which the opposing end 34 could be threaded, or latched similar to a traditional belt. VELCRO hook and loop tape or the like could also be used to secure the ends 34 and 36 to one another. The elongated member 32 could comprise a simple strap or belt, or a harness-like member, as illustrated. Preferably, the harness 30 is cushioned so as to provide comfort to the user of the device 10.

With continuing reference to FIGS. 1-3, one or more resistance bands 40 are interconnected between the elongated member 32 and a stationary object, preferably the stanchion 28 of the treadmill 12. The resistance bands 40 are comprised of resiliently flexible material such as elastic or bungee material which can be stretched to a certain degree with the application of sufficient force, yet return to its at rest state once the force is removed.

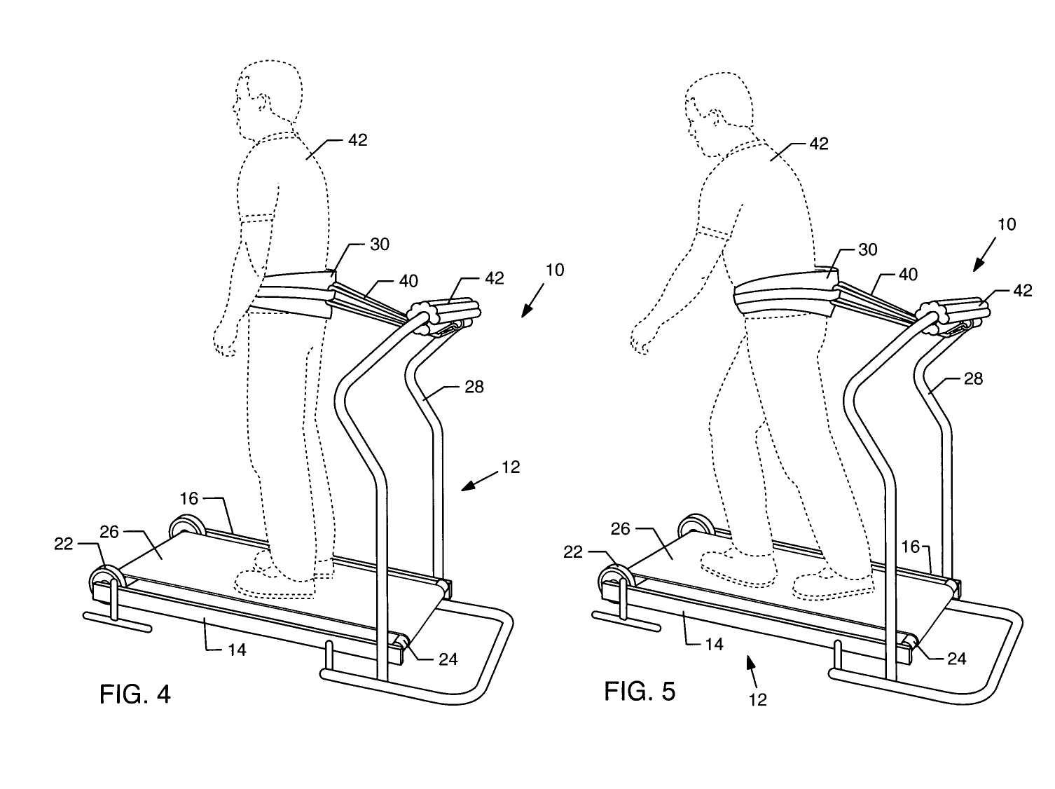

With reference now to FIGS. 4 and 5, in use, a user 42 places the harness 30 about his or her waist and attaches the free ends 34 and 36 to one another to form a generally tight fit around the user's waist. FIG. 4 illustrates the user in an at rest and stationary position with the harness 30 coupled to the user's waist and the resistive bands 40 extending between the harness 30 and the rear stanchion 28. It will be appreciated by those skilled in the art that the resistive bands 40 could be elongated so as to extend between a wall, pole, or other stationary and fixed object relative to the treadmill 12 to provide the same effect.

With reference now to FIG. 5, as the user 42 begins to walk, jog, or run, the belt 26 rotates in response thereto. This causes the user 42 to move forward in position. However, the resistive bands 40 provide resistance to this forward movement. The degree of resistance is directly related to the forward force or speed of the user 42 and the number of quantities of the bands 40. The user 42 can lean forward and attempt to walk forward, however, the resistance bands 40 will resist such motion and limit the forward movement of the user 42. The same resistance is applied when the user 42 runs with a great deal of speed on the manually-operated treadmill 12. Connecting the resistance bands to the rear stanchion 28 or other object directly behind the user 42 enables the user to operate the treadmill 12 comfortably without being pulled at a side angle. Preferably, a cushion 42 is attached to the rear stanchion 28 in the event that the user 42 is pulled backwards by the resistance bands 40 sufficiently so as to make contact with the rear stanchion 28. The level of resistance can be adjusted by either adding additional resistance bands 40, or selecting a resistance band having a greater or lesser degree of resistance.

It will be appreciated by those skilled in the art that the exercise device of the present invention allows a user 42 thereof to improve his or her cardio vascular system as well as strengthen muscles during a workout using the device 10. The device 10 accommodates individual users 42 of different capabilities and strengths as the harness 30 can be adjusted and the resistance from the resistance bands 40 can be adjusted as well. The user 42 can perform such exercises and workouts alone without the need of a trainer.

Although several embodiments have been described in detail for purposes of illustration, various modifications may be made without departing from the scope and spirit of the invention. Accordingly, the invention is not to be limited, except as by the appended claims.

1. An exercise device for providing resistive training for a user of a manually-operated treadmill, the exercise device comprising:
a harness adapted for coupling to a waist of the user; and
a resistance band comprised of a resiliently flexible material and having a first end coupled to the harness, and a second end coupled to an object fixed relative to the treadmill, whereby resistance to forward movement of the user occurs as the user manually operates the treadmill.

2. The exercise device of claim 1, wherein the harness is defined by an elongated member having opposed ends adapted for engagement together around the waist of the user.

3. The exercise device of claim 1, wherein multiple resistance bands are coupled to the harness to increase the resistance to forward movement.

4. The exercise device of claim 1, wherein the second end of the resistance band is coupled to a rear stanchion of the treadmill.

5. The exercise device of claim 1, wherein the second end of the resistance band is coupled to a fixed object in close proximity to the treadmill.

6. An exercise device, comprising:
a manually-operated treadmill; and
a harness including an elongated member having opposed ends adapted for engagement together around a waist of a user of the treadmill and a resistance band comprised of a resiliently flexible material and having a first end thereof coupled to the elongated member, and a second end thereof coupled to an object fixed relative to the treadmill, whereby resistance to forward movement of the user occurs as the user manually operates the treadmill.

7. The exercise device of claim 6, wherein the treadmill comprises a support structure including parallel rails, a leading roller rotatably attached to the rails at one end of the support structure, a trailing roller rotatably attached to the rails at an opposite end of the support structure, and a continuous belt track extending between the rollers so as to be manually rotated by the user.

8. The exercise device of claim 6, wherein the treadmill includes a rear stanchion adapted to be coupled to the second end of the resistance band.

9. The exercise device of claim 8, wherein the rear stanchion extends generally perpendicular to the support structure at a rear end thereof such that the resistance band can be coupled thereto substantially behind the user of the treadmill.

10. The exercise device of claim 6, wherein the second end of the resistance band is coupled to a fixed object in close proximity to the treadmill.

11. The exercise device of claim 6, wherein the harness includes multiple resistance bands to increase the resistance to forward movement.

12. An exercise device, comprising:
a manually-operated treadmill comprising a support structure including parallel rails, a leading roller rotatably attached to the rails at one end of the support structure, a trailing roller rotatably attached to the rails at an opposite end of the support structure, and a continuous belt track extending between the rollers so as to be manually rotated by the user, and a rear stanchion extending upwardly from a rear portion of the support structure; and
a harness including an elongated member having opposed ends adapted for engagement together around a waist of a user of the treadmill and a resistance band comprised of a resiliently flexible material and having a first end thereof coupled to the elongated member, and a second end thereof coupled to an object fixed relative to the treadmill, whereby resistance to forward movement of the user occurs as the user manually operates the treadmill.

13. The exercise device of claim 12, wherein the rear stanchion extends generally perpendicular to the support structure at a rear end thereof such that the resistance band can be coupled thereto substantially behind the user of the treadmill.

14. The exercise device of claim 12, wherein the harness includes multiple resistance bands to increase the resistance to forward movement.
